(19) United States
(12) Patent Application Publication
(10) Pub. No.: US 2015/0268924 A1
(43) Pub. Date: Sep. 24, 2015

(54) METHOD AND SYSTEM FOR SELECTING TRACKS ON A DIGITAL FILE

(71) Applicant: Hipolito Torrales, JR., Columbia, SC (US)

(72) Inventor: Hipolito Torrales, JR., Columbia, SC (US)

(21) Appl. No.: 14/661,575

(22) Filed: Mar. 18, 2015

Related U.S. Application Data
(60) Provisional application No. 61/955,582, filed on Mar. 19, 2014.

(51) Int. Cl. G06F 3/16; G06F 3/0484

(52) U.S. Cl. CPC G06F 3/165; G06F 3/04847; G06F 3/04842

(57) ABSTRACT

A computer file type allows a user to embed different digital tracks as features into a digital file, which features can then be mixed in and out during playback by the user. In addition, the present invention includes a graphical user interface controller to allow selection of the individual features using a slider or radio buttons. For example, a student may want to hear only the orchestral accompaniment only of a digital file of a pianist playing accompanied music in order to practice playing the piano part while listening to the full orchestra. As another example, music or video may be provided with alternatively selectable lyrics in different languages.

### BACKGROUND

Much information is being stored digitally. Among that information, a significant portion of it is stored in parallel track pairs. A suitable composite work may be produced when the individual track pairs are generated separately and then applied to the digital file in a carefully selected mix. When that file is run or played, the output is the combined output of the separate tracks as mixed by the producer.

For example, in audio files, a soloist track pair may consist of two recorded tracks of a singer singing, one from the left side and one from the right side for a stereo recording. Another two tracks, one from the left and one from the right, may be recorded of the sound of an instrument or band playing in accompaniment of the singer. When the resulting mixed audio file is played, the listener hears a stereo recording of the singer accompanied by the instrument or band. When these two sets of tracks are digitally recorded for playback by the customer, they are stored as a single stereo file mixed, meaning as the relative levels of the volume of the tracks of the singer and the tracks of the instrument or band were chosen by a producer for aesthetic or practical effect to bring out the final sound deemed best by that producer. On replay, the stereo mix as recorded can only be heard the way the producer mixed it.

Playback by the end user on stereo equipment or portable players including personal entertainment devices often includes a volume control, which means control over the total volume of the sound produced when a song is played by the stereo or portable player. There may also be volume control (or “balance”) between left and right speakers, which allows adjustment of the relative volume coming from the left and the right speakers. The volume of one side may be lowered relative to the other by changing the balance. Finally, there is sometimes a equalizer control, that is, the volume for each frequency band may be changed, such as by increasing or decreasing the relative volume of base compared to the volume of the treble portion of the audible frequency spectrum of the stereo or player, for example. Level control is accomplished by filtering a portion of the audible frequency band within the total audible band. However, there are no controls for volume by source; for example, changing the volume of the singer per se relative to the volume of the instrumental portion after the recording is made and the tracks have been selected for recording by the producer. Once the tracks at their originally selected relative volumes are laid down on the audio file by the producer, they are fixed.

The foregoing example is specific to music but the same issue applies to other forms of digital information, for example, to digital files that comprise both an audio and a video tracks or plural video tracks.

There remains a need for greater flexibility for the end user, that is, the consumer, of digital information.

### SUMMARY OF THE INVENTION

According to its major aspects and briefly recited, the present invention is a computer file type that allows the user to embed different digital tracks from an original, mixed digital file into channels by source within a subsequently generated digital file in a way that allows the end user, the consumer, the ability to mix the channels in and out during playback and streaming. The present method for playing digital music includes the steps of receiving an original digital file including at least a first pair of tracks from a first source and a second pair of tracks from a second source; combining the first pair of tracks into a first combined track from the first source; combining a second pair of tracks into a second combined track from the second source; generating a second digital file carrying the first and second combined tracks, and providing a user interface for playing the first and second combined tracks together or separately. The user interface includes a play button and a switch with (1) an intermediate position permitting both the first and second combined tracks to be played simultaneously, (2) a first extreme position permitting only the first combined track to be played, and (3) a second extreme position permitting only said second combined track to be played.

The first pair of tracks may be left and right audio tracks and the second pair of tracks may be a left and right soloist tracks such as the singing of a vocalist. There may be a third, fourth and other pairs of tracks that allow the user to mix ad hoc sources from a pre-existing, pre-mixed audiovisual digital file. Which sources are in the original digital file and how they can be combined will depend on that file. Typically, the instrumental portion and the soloist portion are separate sources in a four track data file, perhaps bass drum and cymbals are additional separate sources on an original eight track digital file.

As used herein, a track is digitally stored data, for example, audio data and video data. A channel is a source of digital data, such as a microphone or camera set up to deliver data to a recording device. As used herein, a feature is one or more tracks that are designated to be handled as a unit and which can be selected or de-selected as a unit from other features, according to the present invention.

In addition, the present invention includes a graphical user interface in the form of a slide controller or radio button, either actual or virtual, to allow the user to control the playback of features using the slider switch or rotation of the button, and thereby easily select the feature the user wishes to see or hear. Other user interface controls may be combined with these to facilitate integration of the present invention with audio/video and audiovisual output devices in such a way that the usual function of those devices may still be access as well as the function of the present invention, such as, for example, a button that has selects mode of operation.

In many digital music applications, a user may wish to listen to only some of the recorded features, such as an instrumental feature without the otherwise associated vocal feature, a clean version of a song rather than an explicit version, or a Spanish version of the lyrics rather than an English version. Using a slider switch, a feature may be de-selected by turning down its volume, leaving the other features for the user to see and hear.

Other examples abound. Many people enjoy karaoke, a form of entertainment in which individuals sing popular songs to just the instrumental portion. Special music is available that does not contain the vocal portion (but may include the printed lyrics). The present invention permits simple selection among three options such as vocal with instrumental, just vocal, and just instrumental, so that karaoke singer can simply select the third of these options. For that matter, a musician who is learning the instrumental part of a song may want to deselect the instrumental part in order to provide the accompanying music to the singing of the original vocalist.

Those skilled in the art of digital recording use will recognize other features and their advantages from a careful reading of the Detailed Description of Preferred Embodiments together with the drawings.

### BRIEF DESCRIPTION OF THE DRAWINGS

FIG. 1 is a schematic diagram of a prior art digital file with four tracks, including left and right instrumental tracks and a left and right vocal tracks;

FIG. 2 is a schematic diagram of the present method for producing a second digital file from an original four-track recording combined into a vocal channel and an instrumental channel, according to a first embodiment;

FIG. 3 is a schematic diagram of a digital file with six tracks, including left and right instrumental tracks, left and right clean vocal tracks and left and right explicit vocal tracks;

FIG. 4 is a schematic diagram of the present method for producing a digital file from the original six track recording, including two alternative vocal tracks, one clean and one explicit, and one instrumental track;

FIG. 5A illustrates the user interface for controlling playback of a four track, two channel, recording made according to the present method;

FIG. 5B illustrates the user interface for controlling playback of a six track, two channel, recording made according to the present method;

FIG. 6 is a schematic diagram of a digital file with eight tracks, including a channel with left and right instrumental tracks, a second channel with left and right voice tracks, a channel with left and right “kick” (bass) tracks, and a channel with left and right “hat” (cymbals) tracks;

FIG. 7 illustrates a more flexible user interface for a user to mix eight tracks in four channels of a digital recording made according to the present invention;

FIGS. 8A and 8B illustrate the present method and system in a pre-bounce test layout for mixing four and six track data files;

FIG. 9 is a flow diagram of the present invention, according to an embodiment of the present invention; and

FIG. 10 is a schematic diagram of the audio structure of a data file according to the present invention.

### DETAILED DESCRIPTION OF EMBODIMENTS

As used herein, a track is data stored in digital or analog form, such as audio data and video data. The data in a track may be the sound of a whole orchestra or any section of it or the sounds produced by a single musician playing an instrument or the singing of a single vocalist, even the sound of the bass drum or the cymbals played by the drummer. The data in a video track may be the sequence of images that comprise a motion picture or just the camera feed from a live sports event, or in combination of the audio data produced by the sounds of the actors in the motion picture or the announcers that provide commentary for the sports event.

A channel is a source of digital data, such as a the sounds picked up by a microphone or the images collected by a camera when they are set up to deliver audio or video data, respectively, to a wire or cable through which the channel data, that is the digital data from that source, is directed to a receiver or to a wireless feed from these. These terms are used in a manner similar to the way they are used by those skilled in the recording arts, particularly those skilled in the operation of digital audio workstations.

The term feature, as used in this specification, is relevant to the choices a consumer may make when using the present invention and may be designated as such by the producer of the digital file. The producer may group the output of one or more channels to provide a feature. The consumer may choose one feature over others or choose a blend or mix of features. According to the present invention, the sounds produced by a soloist musician or by a vocalist are examples of likely features of a data file; sounds of a band supporting the solo musician or vocalist may be another feature. Alternatively, each musician in a string quartet may be a separate feature if the sounds of each are separately captured in a different channel. The designation of what is included and excluded in a feature is made based on the likely use of the recording by the customer and the use of separate channels for capturing the digital data from that source. A feature, then, is one or more tracks from one or more channels mixed and recorded as a feature by the producer who intends for the customer to decide to play that feature alone or together with other features. Importantly, the consumer has a choice regarding which features are playable separately or together with other features.

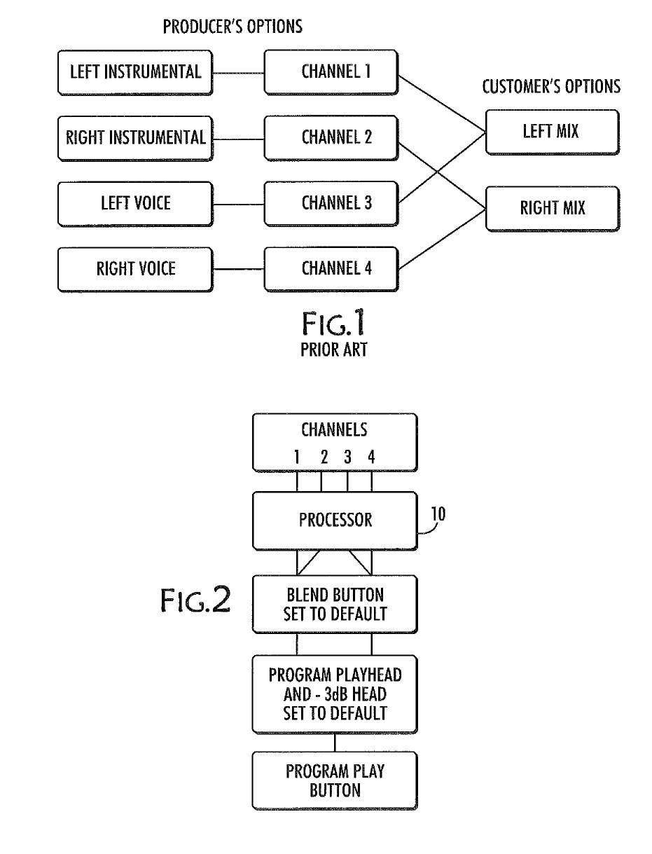

FIG. 1 shows four tracks from four channels in a pattern suitable for using the present software system and method. A typical prior art audio file comprises only a single stereo data file that contains all the information—a left instrumental and a left vocal are premixed and the right instrumental and right vocal are premixed. The file made according to the present method is also a single data file. However, unlike the prior art data file, the tracks of it are controllable by the user with the present software-based method so that the instrumental tracks, left and right, are combined by the software for play as one feature and the vocal tracks, left and right, are combined for play as another feature.

FIG. 2 shows schematically how the four tracks are bundled into two channels. The original four tracks, channels 1-4, in FIG. 1, are combined by a programmed processor 10 to yield an instrumental feature bundled in channel 1 from channels 1 and 2, namely, left and right instrumental channels, and a voice feature is bundled in channel 4, from channels 3 and 4, namely, the left and right vocal channels. The two separate channels, 1 and 4, are laid down as part of the same data file. The present software pre-selects the playing of these two channels to a default setting in which both features are played together in a blended mix, so that the listener hears, when listening to that default condition, the same thing that the user would have heard without the present program: the two voice and two instrument tracks being played as if they were all pre-mixed by the producer as usual. However, the user of the present invention may now select channel 1, the instrumental portion only, or channel 4, the vocal portion only, instead of the blended sound. The sound of just channel 1 is only the instrumental and not the vocal; the sound of just channel 4 is only the vocal and not also the instrumental.

Normally, for a user to control play of a song in this manner, the instrumental and vocal must be in two completely separate stereo files. A mixer blend between the two would be made to see how they fit by raising the individual volumes of each track using the mixer. In this manner, each may be separately controlled. The present system and method, however, temporarily generates a first new file by combining left and right tracks for each of the vocal channels and a second file of the combined instrumental channels so the user can select either channel, vocal or instrumental, or the blend of vocal and instrumental that she wants to hear.

As an example of the use, the user may want to sing the vocal part with the instrumental part in accompaniment, so the soloist's volume would be reduced by the user. Alternatively, the user may want to accompany the soloist, so the user would reduce or eliminate the instrumental accompaniment, leaving just the soloist's part.

The volume of play is set by the processor at a nominal 100% of the volume selected by the original producer. In one embodiment of the invention, the volume may be reduced gradually and smoothly from 100% to 0% using a slide switch. Furthermore, the processor reduces the volume at the completion of a song by a default reduction, of −3 dB, until a new song is added, at which time the volume is changed back, by +3 dB, to full volume.

If the user wants to play just one feature, such as the instrumental or perhaps the voice and not the other, she first clicks or presses once on the program play button to start the song and then moves a slide to either the left or right end of the slide's travel to select the feature of choice. If she wants to pause the playing, she clicks or presses the play button again. If she wants to replay the song, she clicks or presses the play button twice for “back to the top.” Whenever a new song is loaded, the sequence restarts from the beginning regardless of whether the previous song played to completion.

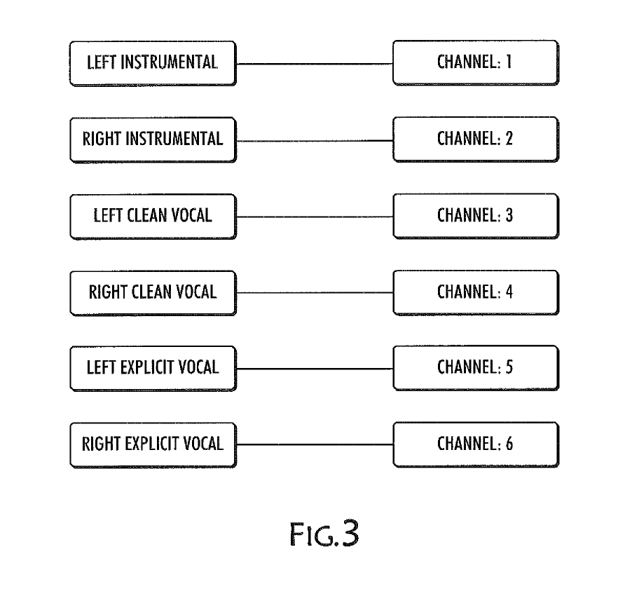

FIG. 3 schematically shows six tracks for a six track recording, including a left and right instrumental channel, a left and right vocal channel that contain no explicit language (i.e., the language is “clean”), and another left and right vocal channel that contain explicit language. An alternate example of use of two sets of lyrics is a song sung alternately in English and Spanish.

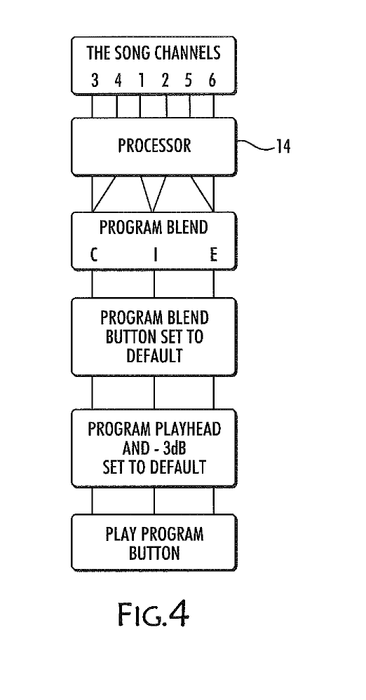

FIG. 4 shows a similar process to that of FIG. 2 but includes the third pair of channels. Six channels are received by the present processor 14. Channels one and two are combined to produce an instrumental channel, that is, without the vocal part; channels three and four are combined to produce two vocal channels with clean lyrics (or, in the alternative example, lyrics in English) and channels five and six combine the vocal channels with the explicit lyrics (or, in the alternative example, lyrics in Spanish).

During playback, the music can be played with only one or the other set of lyrics but not both sets. The instrumental portion is then made playable at 100% volume by itself when the slide is in the middle of its range. If the explicit lyrics are preferred, the slide is moved to the extreme right. If the clean lyrics are preferred, the slide is moved to the extreme left. In any position, the instrumental is heard but there is slide position that allows both the clean and the explicit lyrics to be heard simultaneously.

The ability to switch lyrics is an important feature of the invention. Currently there are place and time restrictions imposed on the playing of music that contains explicit language. To enable radio stations to comply, two versions of this music have to be prepared and distributed. In the present invention, the two extra tracks of a six-track digital sound recording can be used to carry the explicit version of the vocal and, using the present invention, the user can select the version to be played, with a substantial reduction in storage requirement.

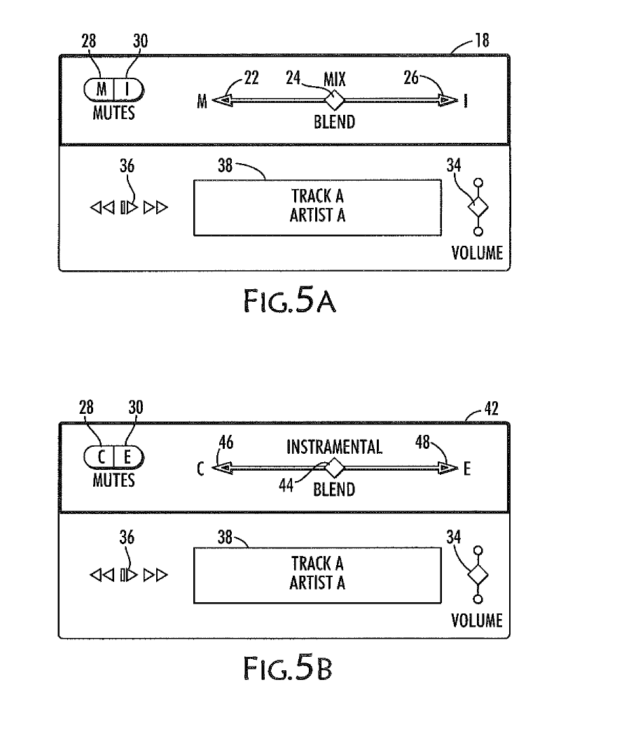

In FIG. 5A, interface 18 received the output of processor 10 and is therefore capable of enabling the user to select the mix of soloist instrumental and music accompaniment when slide switch 24 is in the middle of its range. By sliding switch 24 to the extreme left end 22, the music accompaniment is heard by the solo instrumentalist is no longer heard; by sliding switch 24 to the extreme right end 26, only the soloist is heard and the musical accompaniment is no longer audible. Using mute buttons 28, 30 instantly mutes the music accompaniment and the solo instrumentalist, respectively.

Regardless of the position of slide switch 24, the overall volume can be controlled with slide switch 34, and the play button 36 can be used to control play, pause, fast forward and rewind. One press of play button 36 starts play of the song, a second press pauses play, and a third resumes play. Pressing to the right of play button 36 causes the song to “fast forward” to the next song; pressing to the left of play button 36 replays the song from the beginning. A display 38 may be used to show the name of the performers, the song title and other information.

FIG. 5B is similar to FIG. 5A but with a fundamental difference because it receives the output of processor 14. Interface 42 operates with three channels using a slide switch 44 similar to slide switch 24. (All other controls of user interface 42 are the same as those of interface 18 and have the same reference numbers.) Unlike slide switch 24, with all sounds heard in the central position, the user hears just the instrumental blend when slide switch 44 is in its central position. By sliding slide switch 44 to the extreme left end 46, the user can hear the instrumental with “clean” lyrics. By moving slide switch 44 to the extreme right end 48, the user can hear the instrumental blend with “explicit” lyrics.

As with user interface 18, user interface 42 has mute buttons 28, 30, so that the clean or the explicit lyrics can be muted, respectively. The user may also control overall volume with a volume slide switch 34 and there may be a button 36 that controls play, pause, fast forward and rewind. User interface 38 also includes a display of information relevant to the song being played.

Note that, in the user interface, the slide switch may be real or virtual; the play button may be real or virtual. Also, the use of a slide rather than a toggle or three position switch or radio dial is a feature of the invention. Slide switches are commonly used as level switches on electronic sound mixing equipment so knowing how to operate a slide switch to favor one channel over another will seem natural to the user.

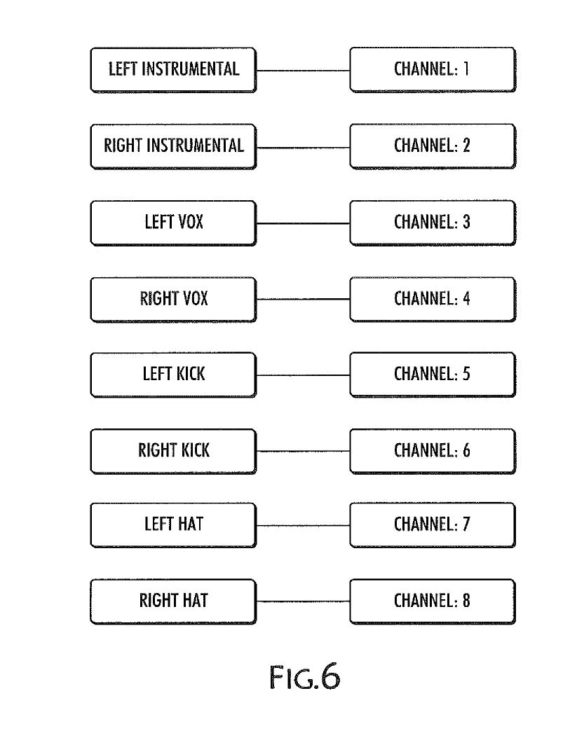

FIG. 6 illustrates schematically an eight track version. In this example, the first and second channels are from the left and right instrumental channels; the third and fourth channels are from the left and right voice channels; the fifth and sixth channels are those from the left and right bass drum (kick) channels; and the seventh and eighth channels are those from the left and right cymbals (hat) channels. Many other possibilities of sources exist, such as, the four instruments in a woodwind or string quartet or the four voices in a barbershop quartet.

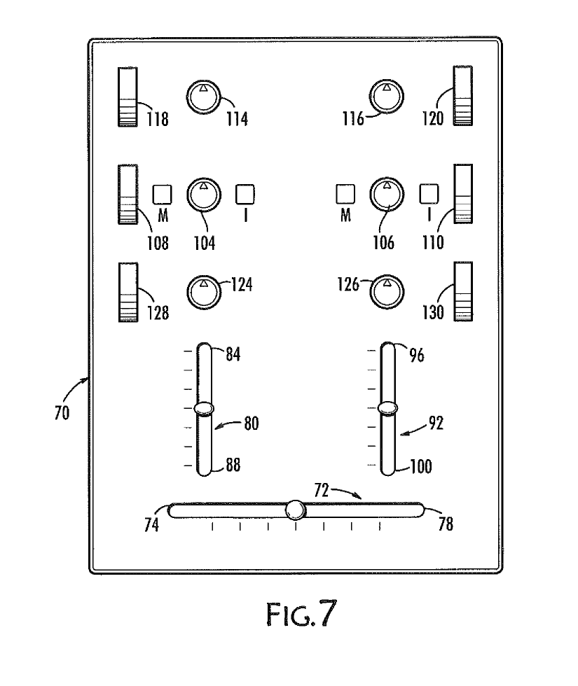

FIG. 7 illustrates another embodiment of an alternate user interface 70. Interface 70 has a first slide switch 72 that allows the user to select away from the blend of instrumental and vocal in the default center position to instrumental only by moving slide switch 70 to the extreme left end 74, or to the extreme right position 78 to select vocal only.

A second slide switch 80 enables the user to provide full bass drum sound at the extreme top position 84 or eliminate it at the extreme bottom position 88, and to adjust the full cymbal sound using a third slide switch 92 by moving slide switch 92 to the extreme top end 96 of the slide range or to having no cymbal sound at the extreme bottom end 100 of slide switch 70.

Other controls on interface 70 can complement slide switches 72, 80, 92, such as radio dials 104 for the left speaker and 106 for the right speaker to separately adjust the blend of music and instrumentalist by speaker and adjust the volume of each speaker using volume controls 108, 110.

The balance between left and right speakers can be chosen for the cymbals separately using left and right radio dials 114, 116, respectively, and left and right cymbal volume controls 118, 120 used to adjust volume. Similarly, the bass drum sounds from the left and right speakers can be controlled using radio dials 124, 126, respectively, and left and right drum volume controls 128, 130.

Other variations on the user interfaces 18, 42, and 70 will be readily appreciated by those of ordinary skill. For example, a typical volume control button used with a radio can be replaced by a two function dial button that, when pressed, converts it to a feature selection dial button that enables the radio operator to select Spanish or English lyrics of a song. Pressing the dial button a second time, restores it to being a button that allows the radio operator the ability to adjust the overall volume.

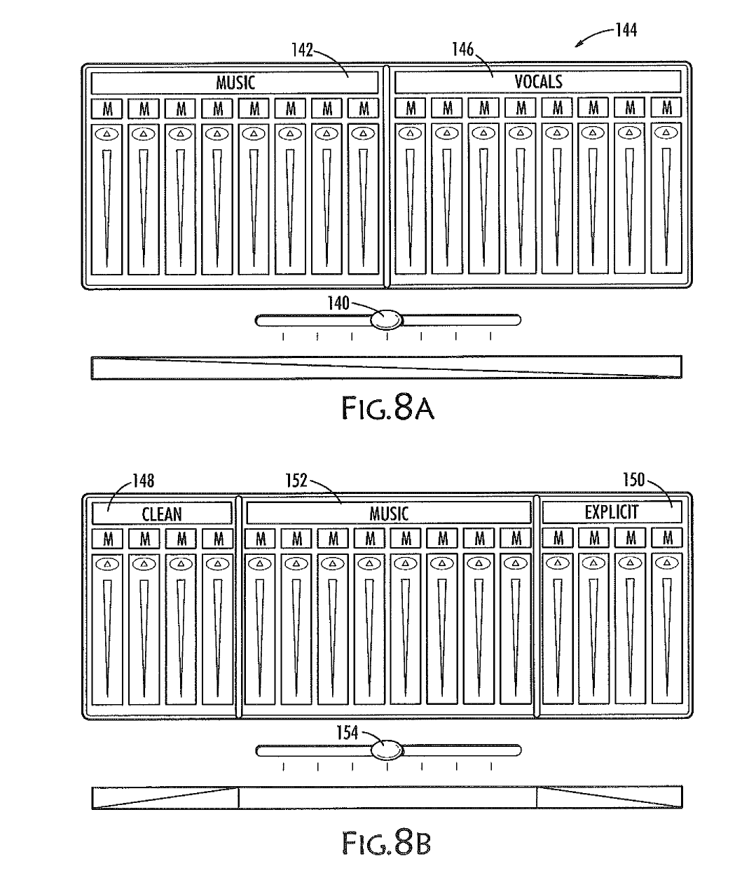

The present invention, while illustrated as providing choices for an end user, such as a retail customer of music, may also be used by intermediate customers, including a music producer. FIG. 8A illustrates that a producer may have many channels in a professional version of a user interface 144 of the present invention, and therefore possesses the ability to adjust the volume of each track to generate a music-only mix 142, a vocal-only mix 146, and, using slide controls 140 to adjust the relative volume levels between instrumental and vocal mixes 142, 146, in the combined mix. The use of the present method in mixing by a producer enables her to mix the two features individually and in combination.

As shown in FIG. 8B, using slide controls 154 to choose among alternative versions of lyrics, one clean and one explicit, for example. The producer can mix the instrumental version 152 with either one of two vocal versions 148, 150, and within the individual tracks for each vocal version 148, 150, and instrumental version 152.

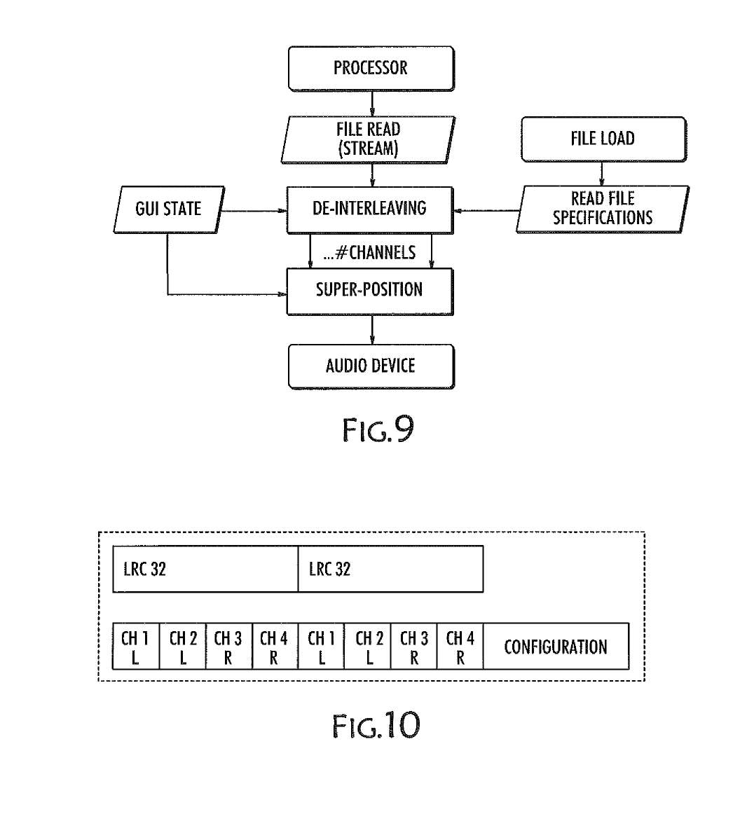

FIG. 9 is a flow diagram of the present method. Beginning at the right, the data file is loaded and its specifications are read. These specifications include the number of channels to interleave and what each channel correlates to. This operation is completed only once. Interleaving (and de-interleaving) is a temporary multiplexing technique known for efficiently processing digital signals with less equipment. Here, however, it prepares the data files from multiple channels to be combined into half the channels.

The processor reads the streaming data files for each channel, and based on the specifications of the file, de-interleaves each channel. The de-interleaved multiple files are super-positioned into individual channels with their respective gains and fades, and outputted to the audio device for playing. This process is looped until the end of the file is reached.

De-interleaving is controlled by the GUI (graphical user interface). As the audio stream moves forward, and the frames are de-interleaved into their respective channels, any additional gains and fades are performed in conjunction with this process.

FIG. 10 shows schematically the interleaved data structure of a four channel data file, according to the present invention. The data file in this data packet complies with real time transport (RTP) protocol for delivering audio and video over internet protocol networks. Each session will have a separate data packet structure for each feature. The lead segment will contain a 16 bit code containing channel configuration, bit rate, and sample rate information. It is followed by a sequence of 16 bit integers containing alternating data samples, first from the right, then left, then right, and then left channels, thereby interleaving the left and right stereo channels. The length of the data sample may be other than 16 bit.

This data is subjected to error detection based on a 32-bit cycle redundancy check (CRC) which is sent with the packet. The right and left channels interleave when the CRC32 matches. In the event the two do not match, the left channel will be duplicated to replace the right channel and the rebuilt data file will be smoothed electronically.

Prior art audio delivery technology provides the consumer with only the capability of selecting and deselecting left and right stereo tracks for music with and without video. The present invention allows an several features to be mixed temporarily by the consumer on the fly in the moment of play.

The present invention may be implemented virtually. A software interface may be used in connection with a digital audio synthesizer and various instrument and effect plugins, audio editors and recording systems. The synthesizer uses digital signal processing to simulate recording studio hardware. Plugins operate as part of a digital audio workstation (DAW) and may provide either instrument simulation or musical effects. Plugins may also include the graphical user interfaces that display the virtual equivalent of physical controls such as slide switches, radio buttons and toggle switches.

Additionally, it will be clear to those from careful reading of the present description that various digital data files may be created for consumers to play using the present invention in addition to audio only data files. Audio and video files may be arranged to allow a motion picture to have English and Spanish words that are individually chosen by those in the audience. Especially in providing different versions of words or lyrics, not only is there greater convenience but there is substantial digital data savings when two separate recording are replaced by one with an extra set of words or lyrics.

Those familiar with current audio and audiovisual technology will appreciate from the foregoing description of the embodiments that many substitutions and modification may be made without departing from the spirit and scope of the present invention. In particular, as technology develops, additional capabilities will become available to give customers more choices of how to mix a greater number and variety of the tracks of recorded audio and audiovisual data.

What is claimed is:

1. A method for playing digital music, said method comprising the steps of:
(a) receiving a first digital file including a first pair of tracks from a first source and a second pair of tracks from a second source;
(b) combining said first pair of tracks into a first combined track from said first source;
(c) combining said second pair of tracks into a second combined track from said second source into a second digital file; and
(d) providing a user interface for playing said first and second combined tracks, said user interface including a play button and a switch, said switch having
(i) an intermediate position permitting both said first and said second combined tracks to be played simultaneously,
(ii) a first extreme position permitting only said first combined track to be played, and
(iii) a second extreme position permitting only said second combined track to be played.

2. The method as recited in claim 1, wherein said switch is a slide switch.

3. The method as recited in claim 2, wherein said slide switch is a virtual switch.

4. The method as recited in claim 1, wherein said first pair of tracks are left and right audio tracks.

5. The method as recited in claim 1, wherein said first source is the sound of musical instruments and said second source is a soloist.

6. The method as recited in claim 1, wherein said first source is the source of musical instruments and said second source is a vocalist.

7. The method of claim 1 wherein said first source is an audio file and said second source is a video file.

8. The method of claim 1, wherein said digital file includes a third pair of digital tracks and wherein said method further comprises the steps of:
(a) providing a third pair of tracks from a third source; and
(b) combining said third pair of tracks from said third source into a third combined track, and
wherein, when said switch is in either said intermediate, said first extreme or said third extreme positions, said user interface permits playing said third combined track.

9. The method of claim 1, wherein said digital file includes plural pairs of digital tracks, each track of said plural digital tracks being from an additional source, said method further comprising the steps of:
(a) providing a third pair of tracks from a third source and a fourth pair of tracks from an additional source; and
(b) combining said third pair of tracks from said third source into a third combined track and said fourth pair of tracks from said additional source into a fourth combined source; and
wherein said switch of said user interface is a slide switch, and wherein said user interface includes a second and a third switch, said second switch having a first position and a second position, said third combined track being playable when said third switch is in said first position and not playable when said third switch is in said second position, and said third switch has a first position and a second position, and wherein said fourth combined track is playable when said third switch is in said first position and not playable when said third switch is in said second position.

10. The method as recited in claim 9, wherein said second and third switches are slide switches.

11. The method as recited in claim 9, wherein said third source is a bass drum and said fourth source is a cymbal.

12. The method as recited in claim 9, wherein said second source is an audio file in a first language and said third source is an audio file in a second language.

13. The method as recited in claim 1 wherein said user interface is configured as a digital audio workstation plugin.
